(19) United States
(12) Patent Application Publication
(10) Pub. No.: US 2015/0206280 A1
(43) Pub. Date: Jul. 23, 2015

(54) IMAGE PROCESSING APPARATUS, IMAGE PROCESSING METHOD, AND PROGRAM

(71) Applicant: Sony Corporation, Tokyo (JP)

(72) Inventors: Hiroaki Ono, Kanagawa (JP); Teppei Kurita, Tokyo (JP); Tomoo Mitsunaga, Kanagawa (JP)

(73) Assignee: Sony Corporation, Tokyo (JP)

(21) Appl. No.: 14/415,382

(22) PCT Filed: May 21, 2013
(86) PCT No.: PCT/JP2013/064009

§ 371 Date: Jan. 16, 2015

(30) Foreign Application Priority Data
Jul. 27, 2012 (JP) 2012-167030

(51) Int. Cl. G06T 3/40; H04N 9/04

(52) U.S. Cl. CPC G06T 3/4015; H04N 9/045; G06T 3/4069; G06T 2207/10024

(57) ABSTRACT

An apparatus and a method are provided which have a simple configuration to perform highly accurate demosaic processing. A local region of interest being a region to be processed is selected from a raw image format, and a standard color image is generated based on an input image. Further, a similar local region is selected which has a phase different from that of the local region of interest, and is determined to have high similarity to the local region of interest based on the standard color image. Further, the local region of interest and the similar local region are combined to generate a local region image set with RGB, having each RGB pixel value set to each pixel position of component pixels of the local region of interest. Further, the local region images set with RGB corresponding to different local regions of interest are combined to generate an RGB image having each RGB pixel value set to each pixel position of component pixels of the input raw image format.

### TECHNICAL FIELD

The present disclosure relates to an image processing apparatus, an image processing met hod, and a program. Specifically, the present disclosure relates to an image processing apparatus, an image processing method, and a program which perform demosaic processing for setting colors such as RGB to each pixel of, for example, a raw image format being the output of an imaging device of a camera, or a raw image format only having a pixel value of a specific color set to each pixel.

### BACKGROUND ART

An imaging device used for an imaging apparatus, such as a digital camera, is mounted with for example an RGB color filter array, and has pixels configured to receive incident light of a specific wavelength thereon.

In particular, for example, a Bayer color filter array is often used.

A captured image having a Bayer array is a so-called mosaic image only having a pixel value corresponding to any of RGB colors set to each pixel of the imaging device. An image processing unit of a camera performs demosaic processing. In the demosaic processing, a mosaic image is subjected to various signal processing, such as pixel value interpolation, and all RGB pixel values are set to each pixel. Thereby, a color image is generated and output.

Conventional demosaicing method includes a method for applying a linear filter to sparse data of the RGB colors to linearly interpolate the same color pixel values circumferentially, and each color of RGB corresponding to each pixel is calculated and set. This method has a low calculation cost, but unfortunately has a low output accuracy (restoration accuracy).

Patent Document 1 (JP 2002-64835 A) discloses an advanced demosaicing method. Specifically, the method achieves demosaic processing according to the features of an image by classification adaptation processing corresponding to a part of an oblique line, thin line, or the like of an image.

Further, there is another demosaicing method in which a gradient direction is estimated for each pixel position.

However, these conventional methods have common risk of deterioration in image quality of an output image due to variation in demosaicing accuracy for each pixel position.

Further, Patent Document 2 (JP 4214409 B1) discloses a demosaicing method using super-resolution. However, the method requires repetitive processing for optimizing a pixel value. Therefore, the method disadvantageously has a high calculation cost and requires a processing time. In addition, the method disadvantageously requires a plurality of images to be input, and a memory capacity to be required is increased.

### CITATION LIST

### Patent Document

Patent Document 1: JP 2002-64835 A

Patent Document 2: JP 4214409 B1

### SUMMARY OF THE INVENTION

### Problems to be Solved by the Invention

The present disclosure has been made in view of, for example, the above-mentioned problems, and it is an object to provide an image processing apparatus, an image processing method, and a program which have a simple configuration and achieve highly accurate demosaic processing.

According to processing of one embodiment according to the present disclosure, demosaicing is performed by combining similar regions having different phases for each local region, and variation in demosaicing accuracy according to a pixel position is reduced.

### Solutions to Problems

A first aspect according to the present disclosure is directed to an image processing apparatus including:

an image processing unit configured to set pixel values of a plurality of colors to each pixel position of an input image being a raw image format only having a pixel value of a specific color set to each pixel,

the image processing unit including:

a local region selecting unit configured to select a local region of interest, as a region to be processed, from the input image;

a standard color image generating unit configured to generate a standard color image based on the input image;

a similar local region selection unit configured to select a similar local region having a phase different from that of the local region of interest, and determined, based on the standard color image, to have high similarity to the local region of interest;

a phase combining unit configured to generate a local region image set with a plurality of colors, having the pixel values of the plurality of colors set to each pixel position of component pixels of the local region of interest by combining the local region of interest and the similar local region; and

a local region combining unit configured to input the local region image set with a plurality of colors corresponding to different local regions of interest generated by the phase combining unit, combine the local region images corresponding to a plurality of colors, as the image to be input, and generate an image set with a plurality of colors, having the pixel values of the plurality of colors set to each pixel position of the component pixels of the input image.

Further, in one aspect of the image processing apparatus according to the present disclosure, the input image is a raw image format only having one RGB pixel value set to each pixel position, the phase combining unit generates a local region image set with RGB, having all RGB pixel values set to each pixel position of component pixels of the local region of interest, and the local region combining unit generates an image set with RGB having the all RGB pixel values set to each pixel position of the component pixels of the input image.

Further, in one aspect of the image processing apparatus according to the present disclosure, the standard color image generating unit generates a standard color image having a frequency lower than a sampling frequency of the raw image format.

Further, in one aspect of the image processing apparatus according to the present disclosure, the standard color image generating unit generates a luminance image having a frequency lower than the sampling frequency of the raw image format.

Further, in one aspect of the image processing apparatus according to the present disclosure, the standard color image generating unit generates a standard color image having a cutoff frequency within the range from the sampling frequency fs corresponding to a pixel of a color occupying the largest number of pixels of the raw image format, to ½ of a Nyquist frequency, i.e., fs/4.

Further, in one aspect of the image processing apparatus according to the present disclosure, the raw image format is a Bayer array image, the similar local region selection unit selects three similar local regions corresponding to three different phases corresponding to three kinds of phases different from the local region of interest, and the phase combining unit generates a local region image set with RGB colors, having each RGB pixel value set to each pixel position of component pixels of the local region of interest by combining the local region of interest and the three similar local regions corresponding to the three different phases.

Further, in one aspect of the image processing apparatus according to the present disclosure, the raw image format is a Bayer array image, the similar local region selection unit selects one similar local region having a phase different from that of the local region of interest, and the phase combining unit combines the local region of interest and the one similar local region, further calculates, by interpolation processing, a pixel value of a pixel position from which the pixel value cannot be acquired, in the combining processing, and generates a local region image set with RGB colors, having each RGB pixel value set to each pixel position of the component pixels of the local region of interest.

Further, in one aspect of the image processing apparatus according to the present disclosure, the image processing unit further includes a similar local region combining unit, the similar local region selection unit selects, for each phase, a plurality of similar local regions having phases different from that of the local region of interest and determined to have high similarity to the local region of interest, based on the standard color image, and outputs the selected similar local regions to the similar local region combining unit, and the similar local region combining unit generates one piece of similar local region data for each phase by combining the plurality of similar local regions of each phase, and outputs the generated data to the phase combining unit.

Further, in one aspect of the image processing apparatus according to the present disclosure, the similar local region combining unit performs combining processing by applying weighted addition according to a weight based on similarity to the local region of interest of each similar local region, and generates one piece of similar local region data for each phase, when combining a plurality of similar local regions for each phase.

Further, a second aspect of the present disclosure is directed to an image processing method performed in an image processing apparatus, the method including:

image processing for setting pixel values of a plurality of colors to each pixel position of an input image being a raw image format only having a pixel value of a specific color set to each pixel, the image processing being performed by an image processing unit,

the image processing including:

a local region selecting unit for selecting, from the input image, a local region of interest as a region to be processed;

a standard color image generating process for generating a standard color image based on the input image;

a similar local region selecting process for selecting a similar local region having a phase different from that of the local region of interest, and determined, based on the standard color image, to have high similarity to the local region of interest;

a phase combining process for generating a local region image set with a plurality of colors, having the pixel values of the plurality of colors set to each pixel position of component pixels of the local region of interest by combining the local region of interest and the similar local region; and

a local region combining process for inputting the local region image set with a plurality of colors corresponding to different local regions of interest generated by the phase combining unit, combining the local region images corresponding to a plurality of colors, as the images to be input, and generating an image set with a plurality of colors, having the pixel values of the plurality of colors set to each pixel position of the component pixels of the input image.

Further, a third aspect of the present disclosure is directed to a program for image processing in an image processing apparatus,

the program causing an image processing unit to perform the image processing for setting pixel values of a plurality of colors to each pixel position of an input image being a raw image format only having a pixel value of a specific color set to each pixel,

the image processing including:

a local region selecting unit for selecting a local region of interest as a region to be processed, from the input image;

a standard color image generating process for generating a standard color image based on the input image;

a similar local region selecting process for selecting a similar local region having a phase different from that of the local region of interest, and determined, based on the standard color image, to have high similarity to the local region of interest;

a phase combining process for generating a local region image set with a plurality of colors, having the pixel values of the plurality of colors set to each pixel position of component pixels of the local region of interest by combining the local region of interest and the similar local region; and

a local region combining process for inputting the local region image set with a plurality of colors corresponding to different local regions of interest generated by the phase combining unit, combining the local region images corresponding to a plurality of colors, as the images to be input, and generating an image set with a plurality of colors, having the pixel values of the plurality of colors set to each pixel position of the component pixels of the input image.

It is noted that the program according to the present disclosure can be provided to an information processing apparatus or a computer system which can execute, for example, various program codes, by a computer-readable storage medium or communication medium. Such a computer-readable program is provided to achieve processing according to the program on the information processing apparatus or a computer system.

Other objects, features, or advantages according to the present disclosure will be apparent from the following detailed description based on the embodiments according to the present disclosure or the accompanying drawings. It is noted that a system described in the present description represents a logical set of a plurality of apparatuses, and is not limited to the apparatuses housed in the same casing.

### Effects of the Invention

According to one embodiment of the present disclosure, an apparatus and a method are achieved which have a simple configuration to perform highly accurate demosaic processing.

Specifically, a local region of interest being a region to be processed is selected from a raw image format, and a standard color image is generated based on an input image. Further, a similar local region is selected which has a phase different from that of the local region of interest, and is determined to have high similarity to the local region of interest based on the standard color image. Further, the local region of interest and the similar local region are combined to generate a local region image set with RGB, having each RGB pixel value set to each pixel position of component pixels of the local region of interest. Further, the local region images set with RGB corresponding to different local regions of interest are combined to generate an RGB image having each RGB pixel value set to each pixel position of component pixels of the input raw image format.

The present configuration achieves the apparatus and the method which have a simple configuration to perform highly accurate demosaic processing.

### BRIEF DESCRIPTION OF DRAWINGS

FIG. 1 is a diagram illustrating an exemplary configuration of an imaging device according to one embodiment of an image processing apparatus of the present disclosure.

FIG. 2 is a diagram illustrating a configuration of the imaging device.

FIG. 3 is a diagram illustrating a configuration and processing of an image processing unit of the image processing apparatus according to the present disclosure.

FIGS. 4(a) and 4(b) are diagrams illustrating exemplary generation of a standard color image by the image processing apparatus according to the present disclosure.

FIGS. 5(1) and 5(2) are diagrams illustrating search processing for a similar local region by the image processing apparatus according to the present disclosure.

FIGS. 6(a), 6(b), 6(c), and 6(d) are diagrams illustrating search processing for similar local regions having different phases by the image processing apparatus according to the present disclosure.

FIG. 7 is a diagram illustrating combining of similar local regions having different phases by the image processing apparatus according to the present disclosure.

FIG. 8 is a diagram illustrating combining of similar local regions having different phases by the image processing apparatus according to the present disclosure.

FIG. 9 is a diagram illustrating combining of similar local regions having different phases by the image processing apparatus according to the present disclosure.

FIG. 10 is a diagram illustrating effective combining of a similar local region having a different phase by the image processing apparatus according to the present disclosure.

FIG. 11 is a diagram illustrating combining of similar local regions having two different phases by the image processing apparatus according to the present disclosure.

FIG. 12 is a diagram illustrating combining of similar local regions having two different phases by the image processing apparatus according to the present disclosure.

FIGS. 13(1) and 13(2) are diagrams illustrating combining of similar local regions having two different phases by the image processing apparatus according to the present disclosure.

FIG. 14 is a diagram illustrating a configuration and processing of the image processing unit of the image processing apparatus according to the present disclosure.

FIG. 15 is a diagram illustrating combining of similar local regions having two different phases by the image processing apparatus according to the present disclosure.

### MODE FOR CARRYING OUT THE INVENTION

An image processing apparatus, an image processing method, and a program according to the present disclosure will be described in detail with reference to the drawings. The description will be made according to the following items.

1. About Exemplary Configuration and Operation of Image Processing Apparatus

1-1. About Configuration of Image Processing Apparatus

1-2. About Operation of Image Processing Apparatus

2. About First Embodiment of Demosaic Processing Performed by Image Processing Apparatus according to Present Disclosure

3. About Other Embodiments

3-1. Second Embodiment: Embodiment of Combining Processing only using Similar Region Having Specific Phase, and Pixel Value Interpolation, in Phase Combining Unit 104

3-2. Third Embodiment: Embodiment of Processing using All Similar Local Regions Having Similarity Larger than or Equal to Predetermined Similarity

4. Summary of Configuration of Present Disclosure

### 1. About Exemplary Configuration and Operation of Image Processing Apparatus

First, exemplary configuration and operation of the image processing apparatus according to the present disclosure will be described.

### 1-1. About Configuration of Image Processing Apparatus

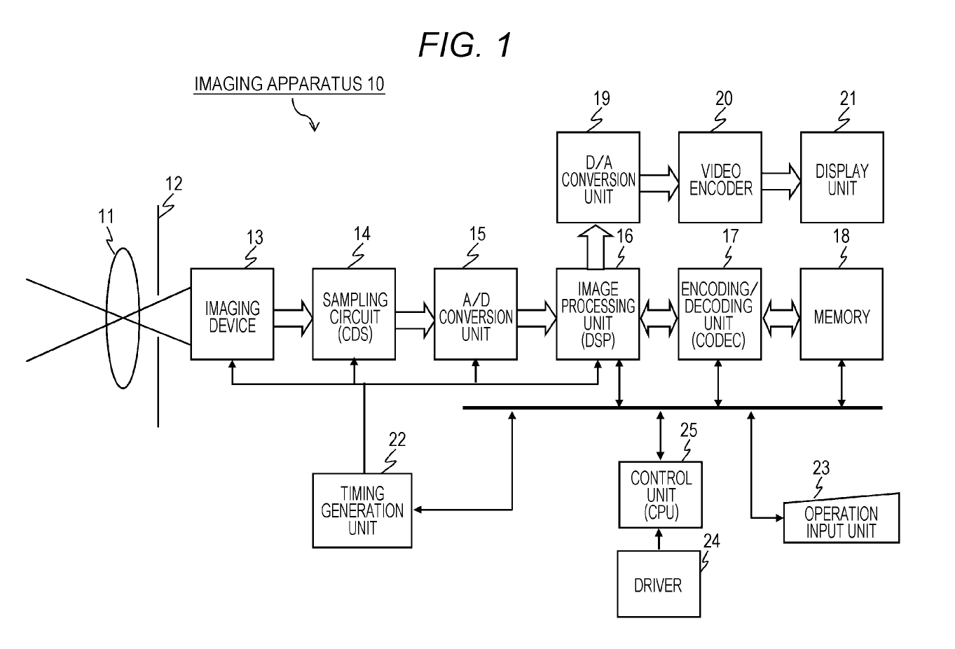

FIG. 1 is a diagram illustrating an exemplary configuration of an imaging apparatus 10 according to one embodiment of the image processing apparatus of the present disclosure. The imaging apparatus 10 mainly includes an optical system, a signal processing system, a recording system, a display system, and a control system.

The optical system includes a lens 11 for concentrating light to form an optical image of an object, a diaphragm 12 for adjusting the amount of the light of the optical image from the lens 11, and an imaging device (image sensor) 13 for photoelectrically converting the optical image formed by the condensed light to an electrical signal.

The imaging device 13 includes, for example, a charge-coupled-device (CCD) image sensor or a complementary metal-oxide semiconductor (CMOS) image sensor.

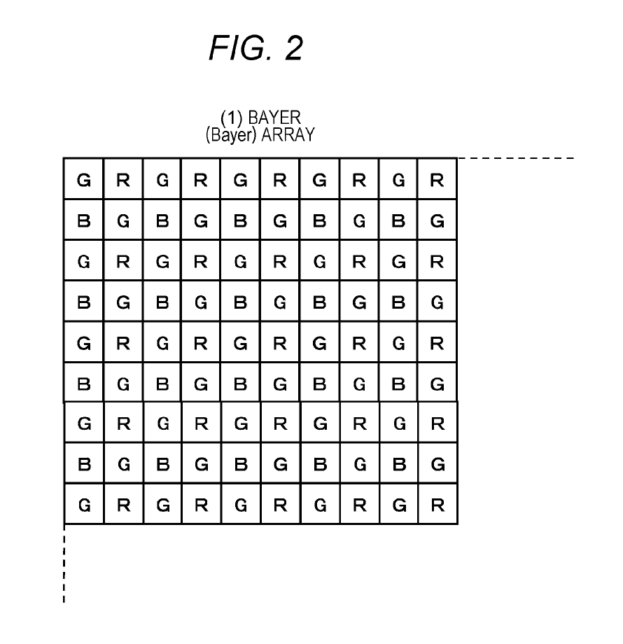

As illustrated in FIG. 2, the imaging device 13 is, for example, an imaging device having a Bayer color filter array including RGB pixels.

Each pixel is set with a pixel value corresponding to any of RGB colors according to a color filter array.

It is noted that the array illustrated in FIG. 2, is an exemplary pixel array of the imaging device 13, and the imaging device 13 can have any of arrays variously set.

Referring back to FIG. 1, description of the configuration of the imaging apparatus 10 will be continued.

The signal processing system includes a sampling circuit 14, an analog/digital (A/D) conversion unit 15, and an image processing unit (DSP) 16.

The sampling circuit 14 is achieved by, for example, a correlated double sampling (CDS) circuit, and the electrical signal from the imaging device 13 is sampled to generate an analog signal. Therefore, noise generated in the imaging device 13 is reduced. The analog signal obtained in the sampling circuit 14 is an image signal for displaying a captured image of an object.

The A/D conversion unit 15 converts the analog signal supplied from the sampling circuit 14 to a digital signal, and supplies the converted digital signal to the image processing unit 16.

The image processing unit 16 subjects the digital signal input from the A/D conversion unit 15 to predetermined image processing.

Specifically, as described with reference to FIG. 2, demosaic processing is performed for setting pixel values corresponding to all RGB colors to each pixel position, for image data (mosaic image) including pixel value data of any one of RGB colors for each pixel.

The demosaic processing will be described later in detail.

It is noted that the image processing unit 126 also performs signal processing in a general camera, such as, white balance (WB) adjustment or gamma correction, in addition to the demosaic processing.

The recording system includes an encoding/decoding unit 17 configured to encode or decode the image signal, and a memory 18 configured to record the image signal.

The encoding/decoding unit 17 encodes the image signal as a digital signal processed by the image processing unit 16, and records the encoded image signal in the memory 18. The encoding/decoding unit reads the image signal from the memory 18, decodes the image signal, and supplies the decoded image signal to the image processing unit 16.

The display system includes a digital/analog (D/A) conversion unit 19, a video encoder 20, and a display unit 21.

The D/A conversion unit 19 converts the image signal processed by the image processing unit 16 into an analog signal, and supplies the analog signal to the video encoder 20. The video encoder 20 encodes the image signal from the D/A conversion unit 19, into a video signal of a type adapted to the display unit 21.

The display unit 21 is achieved by a liquid crystal display (LCD) and the like, and displays an image corresponding to the video signal, based on the video signal obtained by the encoding in the video encoder 20. Further, the display unit 21 also functions as a finder upon imaging the object.

The control system includes a timing generation unit 22, an operation input unit 23, a driver 24, and a control unit (CPU) 25. Additionally, the image processing unit 16, the encoding/decoding unit 17, the memory 18, the timing generation unit 22, the operation input unit 23, and the control unit 25 are connected to each other through a bus 26.

The timing generation unit 22 controls operation timing of the imaging device 13, the sampling circuit 14, the A/D conversion unit 15, and the image processing unit 16. The operation input unit 23 includes a button, a switch, or the like. When shutter operation or another command input by a user is received, a signal according to user's operation is supplied to the control unit 25,

The driver 24 is connected with a predetermined peripheral device, and the driver 24 drives the connected peripheral device. For example, the driver 24 reads data from a recording medium, such as a magnetic disk, an optical disk, a magnetooptical disk, or a semiconductor memory, which is connected as the peripheral device, and supplies the data to the control unit 25.

The control unit 25 controls the imaging apparatus 10 as a whole. For example, the control unit 25 includes a CPU or the like having a program execution function, reads a control program from the recording medium connected to the driver 24 through the memory 18 or the driver 24, and controls the operation of the imaging apparatus 10 as a whole based on the control program, the command from the operation input unit 23, or the like.

### 1-2. About Operation of Image Processing Apparatus

Next, operation of the imaging apparatus 10 illustrated in FIG. 1 will be described.

The imaging apparatus 10 causes incident light from the object, or an optical image of the object, to enter the imaging device 13 through the lens 11 and the diaphragm 12, photoelectrically converts the optical image using the imaging device 13, and generates an electrical signal.

From the electrical signal obtained at the imaging device 13, a noise component is removed by the sampling circuit 14. The electric signal is converted to a digital signal by the A/D conversion unit 15, and then temporarily stored in an image memory such as a frame buffer, not illustrated, included in the image processing unit 16.

It is noted that, in a normal condition or a condition before the shutter operation, when the timing generation unit 22 controls the timing for the signal processing system, the image memory (frame buffer) of the image processing unit 16 is constantly overwritten with the image signal from the A/D conversion unit 15, at a fixed frame rate. The image signal in the image memory of the image processing unit 16 is converted from the digital signal to the analog signal by the D/A conversion unit 19, and converted to the video signal by the video encoder 20. The image corresponding to the video signal is displayed on the display unit 21.

The display unit 21 also functions as a finder of the imaging apparatus 10. The user decides a composition while viewing the image displayed on the display unit 21, and presses a shutter button as the operation input unit 23 to direct capturing the image.

When the shutter button is pressed, the control unit 25 directs, based on the signal from the operation input unit 23, the timing generation unit 22 to hold the image signal generated immediately after the shutter button is pressed. Therefore, the signal processing system is controlled so that the image memory of the image processing unit 16 is not overwritten with the image signal.

After that, the image processing unit 16 performs various signal processing, for example, demosaic processing or white balance adjustment processing, for the image signal held in the image memory, and outputs the processed image data to the encoding/decoding unit 17.

The encoding/decoding unit 17 encodes the image data input from the image processing unit 16, and records the encoded image data in the memory 18. The operation of the imaging apparatus 10, as described above, completes capture of the image signals of one frame.

### 2. About First Embodiment of Demosaic Processing Performed by Image Processing Apparatus according to Present Disclosure

Next, A first embodiment of demosaic processing performed by an image processing unit 16 of an imaging apparatus will be described according to the present invention.

FIG. 2 is a diagram illustrating detailed demosaic processing performed by the image processing unit 16 of the imaging apparatus 10 of FIG. 1.

The image processing unit 16 receives a raw image format 51 input from an A/D conversion unit 15.

The raw image format 51 is an image having only one RGB pixel value set to each pixel. Description will be made on the assumption that the raw image format 51 having a pixel array according to the Bayer array illustrated in FIG. 2 is input.

The raw image format 51 is input to a standard color calculation unit 101 and a local region selection unit 102 of the image processing unit 16.

The standard color calculation unit 101 receives the input of the raw image format 51, calculates a standard color pixel value corresponding to each pixel position based on the input image, generates a standard color image having standard color pixel values set to all pixels, and outputs the generated standard color image to a similar local region selection unit 103.

The standard color employs, for example, a luminance value Y. The standard color calculation unit 101 calculates the luminance value Y corresponding to each pixel value for all pixel position of the input raw image format 51, generates a luminance image having luminance values set to all pixels, and outputs the generated luminance image to the similar local region selection unit 103.

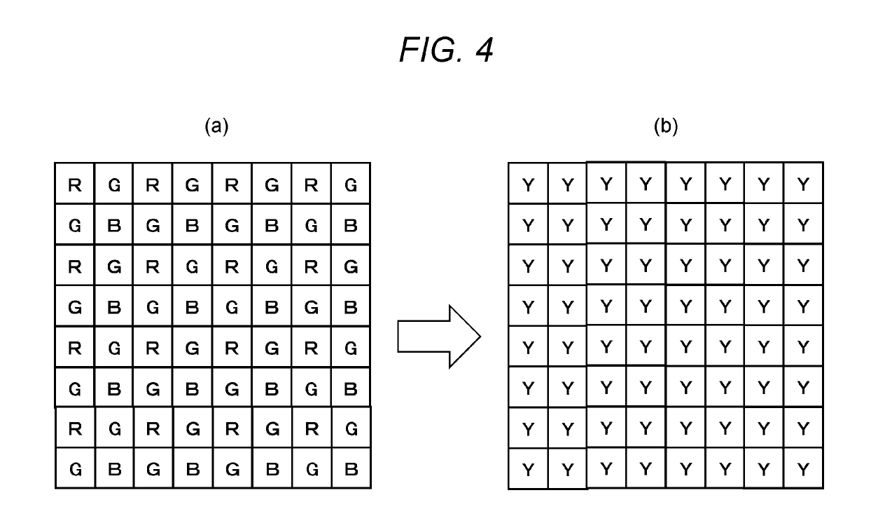

An example of standard color image generation processing performed by the standard color calculation unit 101 will be described with reference to FIG. 4.

It is noted that, in the present embodiment, standard color=luminance (Y), and the standard color calculation unit 101 generates a luminance image 111 having the luminance (Y) value set to each pixel of the raw image format 51.

It is also noted that the standard color may use, for example, a G color occupying the largest number of pixels in the Bayer array. When the G color is used as the standard color, the standard color calculation unit 101 generates, instead of the luminance image, a G image set with G pixels for all pixels.

In the present embodiment, description will be made on the assumption that the standard color calculation unit 101 generates the luminance image 111, wherein standard color=Y (luminance).

FIG. 4(a) is a diagram corresponding to the raw image format 51 input to the standard color calculation unit 101. That is, FIG. 4(a) is a diagram representing the Bayer array having been described with reference to FIG. 2.

Based on the raw image format 51 illustrated in FIG. 4(a), the standard color calculation unit 101 generates the standard color image (luminance image) having the standard color (luminance Y in the present embodiment) set to all pixels illustrated in FIG. 4(b).

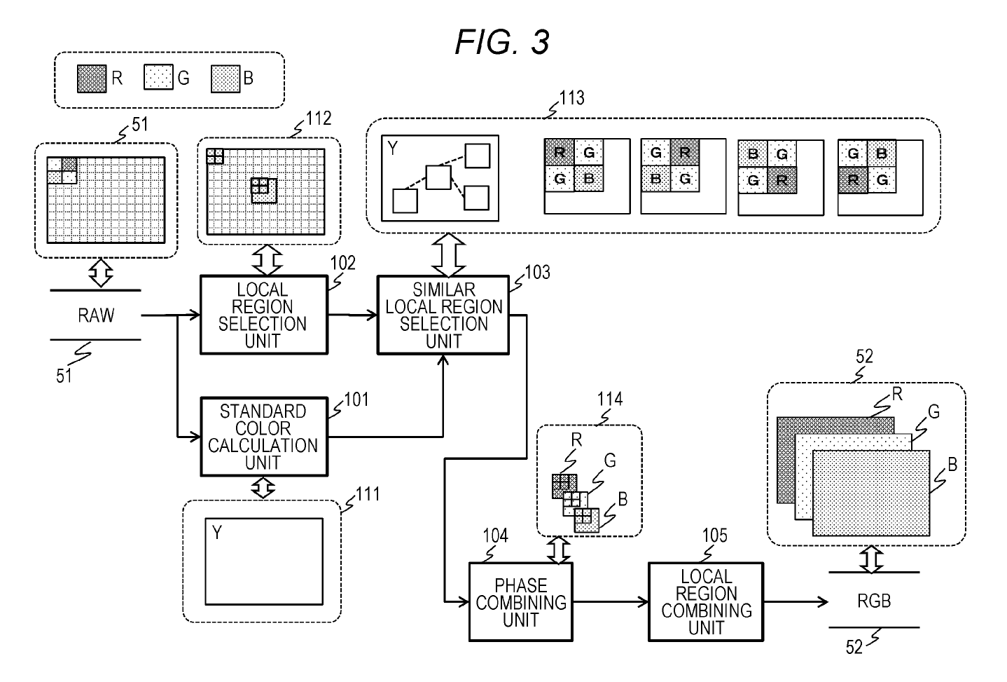

The standard color calculation unit 101 generates the standard color image (luminance image) 111 illustrated in FIG. 3, and outputs the standard color image to the similar local region selection unit 103.

The standard color calculation unit 101 applies a low pass filter, for example, to each RGB pixel value as a set pixel value of the raw image format 51, in order to generate the luminance image illustrated in FIG. 4(b) from the raw image format 51 illustrated in FIG. 4(a). That is, the low pass filter (LPF) is applied to extract a low-frequency component of the pixel value set to the raw image format 51, and calculate the standard color pixel value (luminance value) corresponding to each pixel.

Specifically, for example, the low pass filter (LPF) is applied to calculate the low-frequency component for each region, and a standard pixel value (luminance value) of a pixel of interest is obtained. The low pass filter has a filter coefficient for each pixel, the filter coefficient is set, for example, for each predetermined region around the pixel of interest used for calculation of the luminance value, such as a region of approximately 5×5 pixels.

Owing to the low pass filter (LPF) application processing, as described above, the standard color with a frequency lower than the sampling frequency fs of the input image can be set to all pixels.

In the present embodiment, the standard color (luminance Y) is calculated based on each RGB pixel value, but the standard color may be calculated only using, for example, G information.

In the standard color image including the standard color (luminance Y in the present embodiment), such as the luminance value illustrated in FIG. 4(b) generated by the LPF application processing or the like, a cutoff frequency (frequency having an amplitude of 0.5) is preferably within the range from the sampling frequency fs corresponding to a pixel of a color occupying the largest number of pixels of the raw image format, to ½ of the Nyquist frequency, fs/4, i.e.,

cutoff frequency=fs/4 to fs.

In the formula, fs is the sampling frequency of the largest number of pixels of the raw image format 51. In the present embodiment, the largest number of pixels of the raw image format 51 are G pixels, and the sampling frequency of the G pixel is expressed as follows: sampling frequency of the G pixel=fs.

As described above, the standard color image is preferably has a cutoff frequency set as follows:

cutoff frequency=fs/4 to fs.

The reason why the standard color image set as described above is preferably employed is as follows.

The standard color image generated by the standard color calculation unit 101 is used to select a similar region in the similar local region selection unit 103.

When the cutoff frequency of the standard color image generated by the standard color calculation unit 101 is too small, or the frequency having an amplitude of 0 is too small, too much high frequency information about the standard color (luminance value=Y) is lost, and therefore, accuracy in searching the similar region is reduced in the similar local region selection unit 103.

On the other hand, when the cutoff frequency of the standard color image generated by the standard color calculation unit 101 is too large, or the frequency having an amplitude of 0 is too large, a strong high frequency component of each original RGB color set to the raw image format 51 has a strong influence of a color (phase) different from an intended color to be set to the pixel of interest. In this condition, accuracy in searching the similar region is also reduced, in the similar local region selection unit 103.

It is noted that, in this condition, similarity determination largely affected by the high frequency component of the different color from an objective set color highly possibly results in generation of artifact such as a false color in an output image.

Referring back to FIG. 3, description of the processing of the image processing unit 16 will be continued.

The local region selection unit 102 inputs an image captured by an image sensor having a color filter array, and sequentially selects local regions, for example, rectangular regions of n×n pixels, as a region of interest (local region of interest) to be demosaiced. In this expression, n is an integer of 2 or more.

Information about the local region of interest selected to be processed by the local region selection unit 102 is input to the similar local region selection unit 103 together with the raw image format 51.

The similar local region selection unit 103 uses the standard color image (luminance image) 111 generated by the standard color calculation unit 101 to search a peripheral region for a local region highly similar to the local region of interest selected to be demosaiced by the local region selection unit 102, or the similar region (similar local region).

It is noted that the similarity is determined based on the standard color image (luminance image in the present embodiment).

Upon similar region selection processing, the similar local region selection unit 103 searches for and selects the similar region having a phase different from the local region of interest selected by the local region selection unit 102, or a phase having a color array different from a color array of the local region of interest.

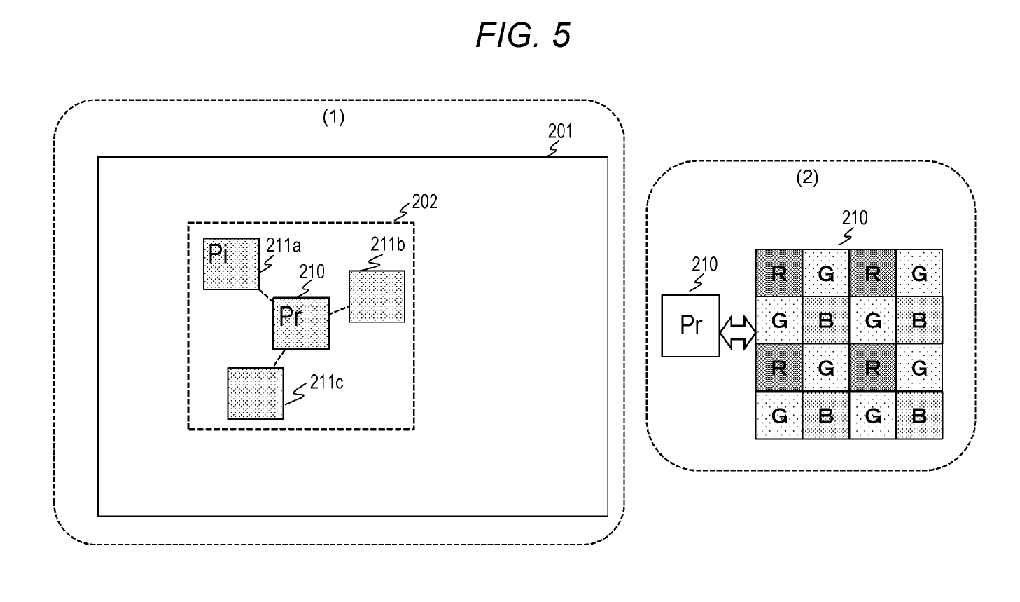

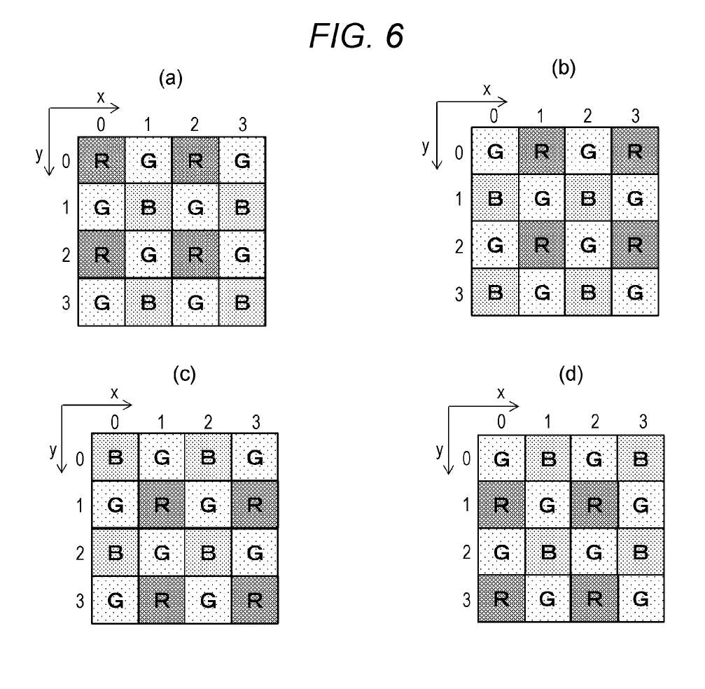

With reference to FIGS. 5(1) and 5(2) and FIGS. 6(a), 6(b), 6(c), and 6(d), a specific example of the similar local region selection processing by the similar local region selection unit 103 will be described in detail, in which the similar local region has a phase different from the phase of the local region of interest.

FIG. 5 (1) illustrates exemplary searching for similar regions 211a to 211c similar to the local region (local region of interest) Pr 210, selected from input raw image format 201, to be processed by the local region selection unit 102. It is preferable that the search is performed by setting a searching range 202 of a predetermined area in the vicinity of the local region of interest.

As described above, upon similar local region selection processing, the similar local region selection unit 103 selects the similar local region determined to have high similarity based on the standard color image (luminance image) 111, from a region having a phase different from the phase (color array) of the local region of interest selected by the local region selection unit 102.

For example, the local region (region of interest) Pr 210 illustrated in FIG. 5 (1) should be assumed to have a phase (color array) illustrated in FIG. 5 (2).

That is, the local region Pr 210 should be assumed to have a 4×4 phase (color array), i.e.,

RGRG,

GBGB,

RGRG, and

GBGB.

For example, when the raw image format 51 with the Bayer array has the local region with the 4×4 color array, the local region has four kinds of different phases illustrated in FIGS. 6(a) to 6(d).

The similar local region selection unit 103 searches for and selects the similar local region being a local region having a phase different from the phase of the local region of interest selected to be demosaiced by the local region selection unit 102, and determined to have a similarity according to similarity determination using the standard color image 11.

When the phase of the local region of interest selected to be demosaiced by the local region selection unit 102 has the phase of FIG. 5(2), or the phase of FIG. 6(a), the similar local region selection unit 103 searches for the similar local region having a phase different from the phase of the local region of interest.

That is, the similar local region selection unit 103 searches for similar local regions having three different phases illustrated in FIGS. 6(b) to 6(d), different from the phase of FIG. 6(a).

The similar local region selection unit 103 selects the followings:

the similar local region having the phase of FIG. 6(b);

the similar local region having the phase of FIG. 6(c); and

the similar local region having the phase of FIG. 6(d),

from the searching range set in the vicinity of the local region of interest. The similar local region having the highest similarity is selected for each phase one by one.

It is noted that local region similarity between the local region of interest and the similar local regions is determined using the standard color image (luminance image) 111 generated by the standard color calculation unit 101.

Specifically, the local region similarity is determined based on comparison using absolute difference (SAD) or difference of squared difference (SSD) of pixel values (luminance (Y) value in the present embodiment) of the local regions of the standard color image (luminance image) 111 generated by the standard color calculation unit 101.

The absolute difference (SAD) or the difference of squared difference (SSD) of the pixel values (luminance (Y) value in the present embodiment) of the local regions of the standard color image is calculated according to (Formula 1) or (Formula 2).

[Mathematical Formula 1]

R_{SAD}=ΣΣ|Pr(x,y)−Pi(x,y)| (Formula 1)

R_{SSD}=ΣΣ(Pr(x,y)−Pi(x,y))² (Formula 2)

Based on the SAD calculated by (Formula 1) or the SSD calculated by (Formula 2), the similar local region selection unit 103 calculates the local region similarity between the local region of interest and the similar local regions, and selects one local region having the highest similarity for each phase.

It is noted that the SAD or the SSD is an index in which a larger similarity is represented by a smaller value.

The similar local region selection unit 103 selects the similar local region having the highest similarity for each phase, and outputs the selected similar local regions to the phase combining unit 104, together with the local region of interest selected to be demosaiced by the local region selection unit 102.

The phase combining unit 104 combines the local region of interest selected by the local region selection unit 102,

and the similar local regions having a phase different from the local region of interest, selected by the similar local region selection unit 103, generates, for each local region of interest, an RGB image 114 (local region image set with a plurality of colors) set with all colors or respective RGB colors to all pixel positions of the local region of interest, and outputs the RGB image 114 to the local region combining unit 105.

For example, processing of the raw image format 51 having the Bayer array is performed as follows.

It is assumed that the local region (region of interest) selected by the local region selection unit 102 has the phase of FIG. 6(a).

The similar region having a phase different from the region of interest selected by the similar local region selection unit 103 serves as similar regions having the three different phases of FIGS. 6(b) to 6(d).

The phase combining unit 104 combines

the local region (region of interest) having the phase of FIG. 6(a), selected by the local region selection unit 102, and

the similar regions having the phases of FIGS. 6(b) to 6(d), selected by the similar local region selection unit 103,

and combines the local regions having the four different phases.

All RGB colors are set to all pixel positions in the local region by the combining processing.

For example, setting an R pixel in all pixel positions in the local region will be described.

As understood from the local regions having the four different phases of FIGS. 6(a) to 6(d), for example, the R pixel is set to the following coordinate points in the local regions of (a) to (d):

coordinate points (0,0), (2,0), (0,2), (2,2) in the local region of (a);

coordinate points (1,0), (3,0), (1,2), (3,2) in the local region of (b);

coordinate points (1,1), (3,1), (1,3), (3,3) in the local region of (c); and

coordinate points (0,1), (0,3), (2,1), (2,3) in the local region of (d).

The R pixel illustrated in (a) to (d) is selected and combined, and the R pixel can be set to all pixel positions in the local region.

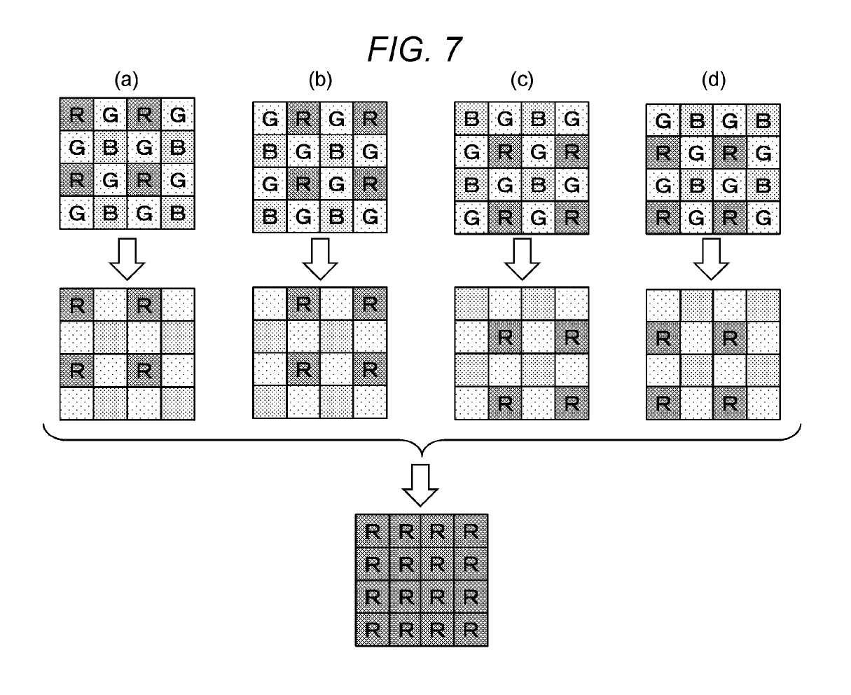

That is, as illustrated in FIG. 7, the R pixel in the different phases of (a) to (d) are selected and combined to generate an R image having an R pixel value set to all pixel positions of 16 pixels, (0,0) to (3,3), of the local region of 4×4 pixels.

The same is applied to a B pixel. In the local regions having the four different phases of FIGS. 6(a) to 6(d), the B pixel is set to the following coordinate points:

coordinate points (1,1), (3,1), (1,3), (3,3) in the local region of (a);

coordinate points (0,1), (2,1), (0,3), (2,3) in the local region of (b);

coordinate points (0,0), (2,0), (0,2), (2,2) in the local region of (c); and

coordinate points (1,0), (3,0), (1,2), (3,2) in the local region of (d).

The B pixel illustrated in (a) to (d) is selected and combined, and the B pixel can be set to all pixel positions in the local region.

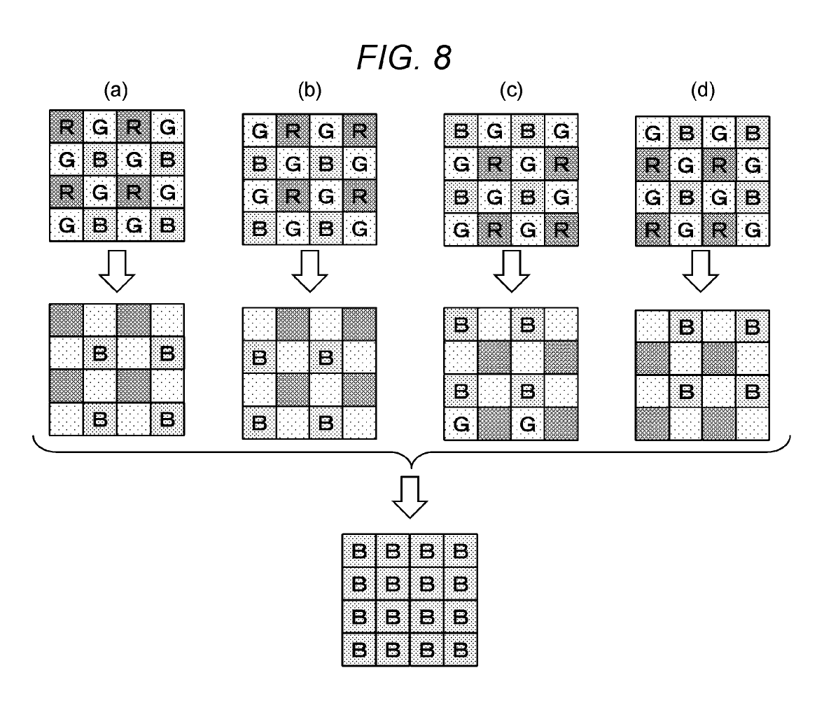

That is, as illustrated in FIG. 8, the B pixel in the different phases of (a) to (d) are selected and combined to generate a B image having a B pixel value set to all pixel positions of 16 pixels, (0,0) to (3,3), of the local region of 4×4 pixels.

A G pixel is configured such that, when the G pixels in the local regions having the four different phases of FIGS. 6(a) to 6(d), two G pixel values are obtained for one pixel.

That is, in the local regions having four different phases of FIGS. 6(a) to 6(d), the G pixel is set to the following coordinate points:

coordinate points (1,0), (3,0), (0,1), (2,1), (1,2), (3,2), (0,3), (2,3) in the local region of (a);

coordinate points (0,0), (2,0), (1,1), (3,1), (0,2), (2,2), (1,3), (3,3) in the local region of (b);

coordinate points (1,0), (3,0), (0,1), (2,1), (1,2), (3,2), (0,3), (2,3) in the local region of (c); and

coordinate points (0,0), (2,0), (1,1), (3,1), (0,2), (2,2), (1,3), (3,3)) in the local region of (d).

The G pixel illustrated in (a) to (d) is selected and combined, and two G pixel can be set to all pixel positions in the local region.

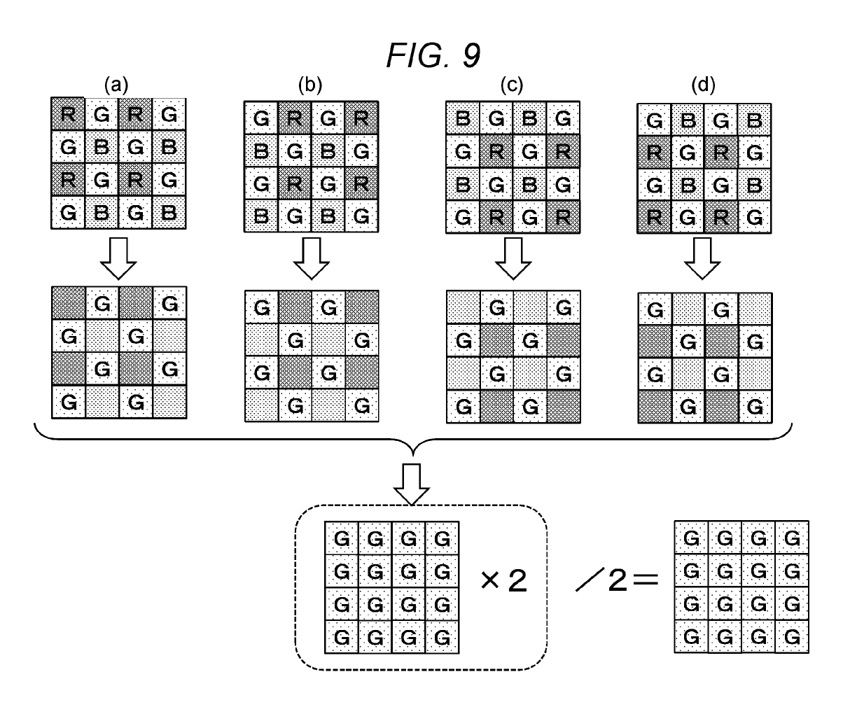

That is, as illustrated in FIG. 9, the G pixel in the different phases of (a) to (d) is selected and combined to generate a G image having two G pixel values set to all pixel positions of 16 pixels, (0,0) to (3,3), of the local region of 4×4 pixels.

For example, one G image can be generated by averaging the two G pixel values for one pixel at each corresponding pixel position.

Alternatively, instead of by averaging, the one G image may be generated, by selecting only a G pixel value in the local region, having higher similarity, where the G pixel value in the local region having a lower similarity is set to be unused, but only one G pixel value is set to be selected for each pixel.

Processing of the local region selection unit 102 to the phase combining unit 104 is performed for all pixel positions of the input raw image format 51, sequentially changing the local regions (regions of interest) to be processed, and the R image, the B image, and the G image for each local region are generated in all pixel positions constituting the raw image format.

Local region RGB images generated by the phase combining unit 104 are sequentially output to the local region combining unit 105. The local region RGB image is represented as a local region RGB image 114 (local region image set with a plurality of colors) in FIG. 3.

The local region combining unit 105 sequentially inputs the local region RGB images 114 generated by the phase combining unit 104, combines the local region RGB images for integration, and generates and outputs an R image having the R pixels set to all pixel positions of the input raw image format, a G image having the G pixels set to all pixel positions thereof, and a B image having the B pixels set to all pixel positions thereof, and an RGB image 52 (image set with a plurality of colors) including R image, the G image, and the B image.

According to the above-mentioned sequence, the image processing unit 16 illustrated in FIG. 3 performs demosaic processing for setting all RGB pixel values to each pixel position of the raw image format 51 being the mosaic image only having one RGB pixel value set to each pixel position, and generates and outputs the RGB images 52.

It is noted that the local regions of interest to be demosaiced may be changed without an overlapping area in each local region, for example, may be sequentially changed for each local region of 4×4 pixels.

Alternatively, the local regions of interest to be demosaiced may be changed by 1 pixel, 1 line, or 1 row, sequentially setting the local region (region of interest) having the overlapping area.

It is noted that when the processing is performed setting the local region having the overlapping area, the processing is performed corresponding to each local region, and the plurality of RGB pixel values for the same pixel position are output from the phase combining unit 104 to the local region combining unit 105.

In this processing, the local region combining unit 105 finally calculates each RGB pixel value of each pixel position by averaging the RGB pixel values of the same pixel position.

Owing to such average processing, variation in output accuracy for each local region is reduced, and accuracy of a final output image is further increased.

The demosaic processing performed in the image processing apparatus of the present disclosure includes the processes of the following steps of:

(step 1) generating the standard color image, for example, the luminance image based on the raw image format;

(step 2) determining the similarity to the local region (region of interest) selected to be demosaiced, based on the standard color image, and selecting the similar local regions having different phases to set all RGB pixel values to component pixel positions of the local region;

(step 3) combining the local region (region of interest) selected to be processed and the RGB pixel values of the similar regions having different phases, and generating the RGB image of each local region; and

(step 4) integrating the RGB images of each local region, and generating the RGB image having RGB pixel values set to each pixel of the input raw image format as a whole.

In the image processing apparatus according to the present disclosure, demosaic processing is performed according to the processes of the above-mentioned steps 1 to 4.

It is noted that the standard color calculation unit 101 in a configuration of the image processing unit 16 of FIG. 3, calculates the standard color having a frequency lower than the sampling frequency of the input raw image format 51. In the similar local region selection unit 103, the similar local regions are searched for according to the similarity determination based on the standard color image.

Owing to the processes, robustness against the noise of the input image is improved.

That is, the standard color calculation unit 101 generates the standard color image such as the luminance image by applying, to the input raw image format 51, for example the low pass filter for calculating a low frequency. The similarity determination based on this low frequency image advantageously improves noise immunity to search for the similar local regions.

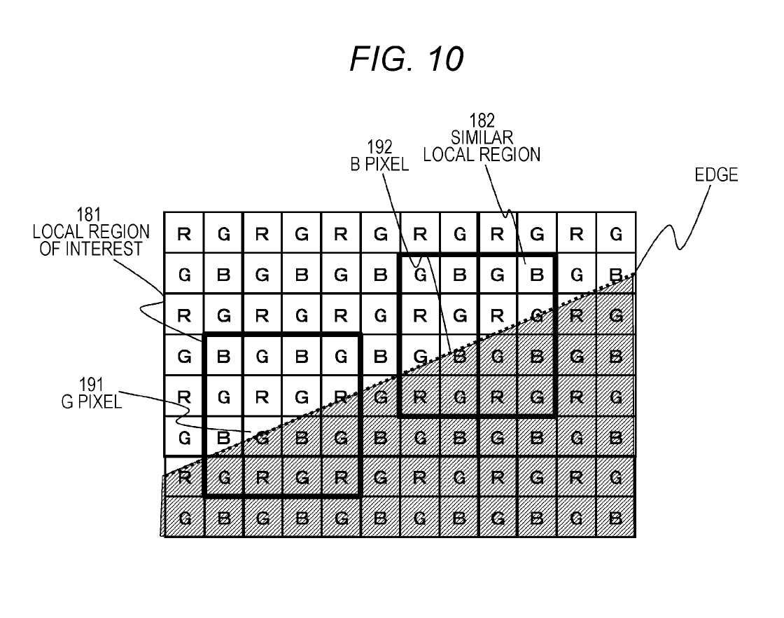

FIG. 10 illustrates an edge, and a raw image format captured by the imaging device (image sensor) having the Bayer array.

For example, it is assumed that the local region of interest 181 selected to be processed according to the above-mentioned processing is on the edge.

When the similarity determination is performed based on the standard color image (e.g, luminance image), the similar local region 182 similar to the local region of interest 181 on the edge is also detected on the edge.

In the above-mentioned processing according to the present disclosure, the pixel values of the similar local regions selected from the edge are combined to set the RGB pixel values to each pixel constituting the local region of interest 181, and the RGB pixel values on the edge can be accurately reproduced.

For example, the B pixel value to the position of G pixel 191 of the local region of interest 181 is set as the pixel value of the B pixel 192 on the edge in the similar local region 182, and the RGB pixel value on the edge can be accurately reproduced.

It is because the input raw image format 51 unprocessed has a plurality of phases and the similarity between the different phases cannot be calculated on the same basis that the similar local region is searched for based on the standard color image 111 such as the luminance image.

In the above-mentioned embodiment, the luminance image is employed as the standard color image, but the processing may be performed, for example, by setting a standard image including the G image having the standard color of G color occupying the maximum number of pixels in the Bayer array.

### 3. About Other Embodiments

Next, other embodiments of processes different from the above-mentioned first embodiment will be described.

### 3-1. Second Embodiment

### Embodiment of Combining Processing Only Using Similar Region Having Specific Phase, and Pixel Value Interpolation, in Phase Combining Unit 104

First, as a second embodiment of an image processing apparatus according to the present disclosure, description will be made of combining processing only using a similar region having a specific phase, and pixel value interpolation, which are performed in a phase combining unit 104 to generate an RGB image for each local region.

The image processing apparatus according to the present second embodiment also includes, for example, an imaging apparatus illustrated in FIG. 1, as similar to the first embodiment having been described above.

An image processing unit 16 also has a configuration of FIG. 3, as described in the first embodiment.

In the second embodiment, search processing for similar regions by a similar local region selection unit 103 and combining processing by the phase combining unit 104 are different in process from the first embodiment.

In the above-mentioned first embodiment, the phase combining unit 104 combines the similar local regions, and the local region of interest having four different phases, selected from the raw image format having the Bayer array, and sets all RGB pixel values to all pixel positions in the local region.

In the present second embodiment, combining processing is performed using only two local regions, i.e., a local region having two different phases, that is, a local region of interest, and another similar local region different from the local region of interest, in the phase combining unit 104.

It is noted that RGB pixel values cannot be set to all pixel positions only by combining processing of the similar regions having two phases, but interpolation processing is applied to the pixel position to which the pixel value cannot be set to set the pixel value.

For example, it is assumed that the local region of interest being a region of interest selected by a local region selection unit 102 has a phase of FIG. 6(a).

In this condition, the similar local region selection unit 103 only searches for a phase of FIG. 6(b) as a similar region, and a phase of FIG. 6(d) as a similar region, so that both phases have different G phases.

The similar local region selection unit 103 does not search for a similar region, or a similar region of FIG. 6(c), having the same G phase as that of the local region being the region of interest selected by the local region selection unit 102.

The similar local region selection unit 103 selects the similar regions, or the similar regions of FIGS. 6(b) and 6(d), having the different G phases from that of the region of interest, further selects, from the two phases, a final phase having higher similarity to the region of interest, and outputs data about the selected one similar local region to the phase combining unit 104 together with data about the local region of interest.

The similarity determination is performed based on the standard color image such as the luminance image, as similar to the above-mentioned embodiment.

For example, when the similar region having the highest similarity to the local region of interest to be processed has the phase of FIG. 6(b), the similar local region selection unit 103 selects this one similar local region, and outputs the selected one similar local region to the phase combining unit 104.

The phase combining unit 104 combines the similar local region having the phase of FIG. 6(b) selected by the similar local region selection unit 103, and the local region of interest having the phase of FIG. 6(a), and generates the RGB images 114 (local region image set with a plurality of colors) for each local region.

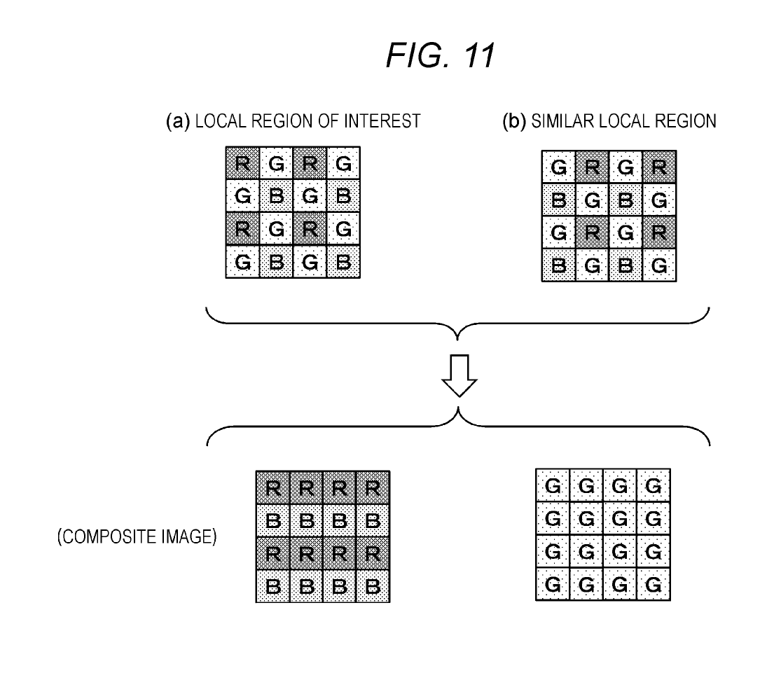

However, the pixel values acquired by the combining processing using the local regions having the two different phases are set as illustrated in composite images of FIG. 11.

That is, for the G pixel value, the pixel values corresponding to all pixels of the local region of interest can be acquired, based on the pixel values of the local regions having two different phases.

However, for R and B pixel values, the pixel values of the pixel positions of ½ of the local region can be acquired, but the other pixel values of the remaining ½ pixel positions cannot be obtained.

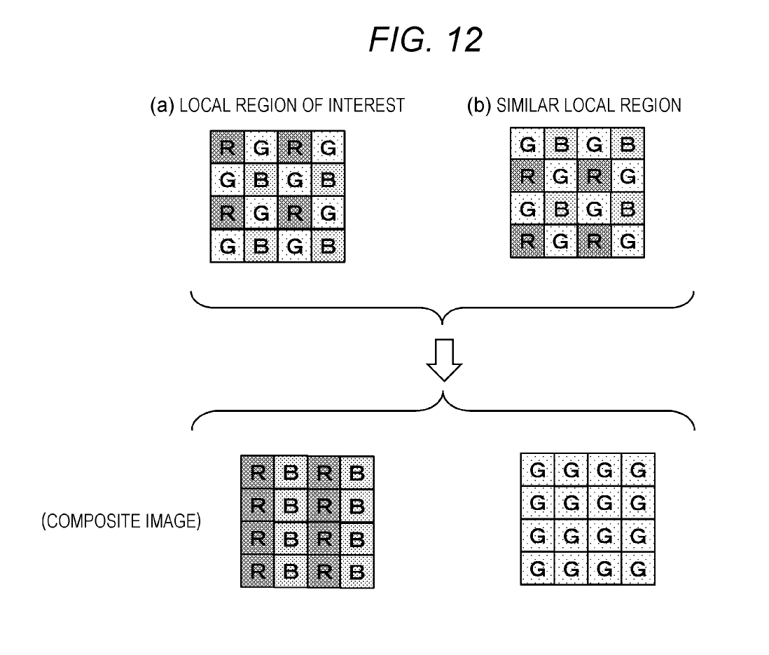

Similarly, when the similar region having high similarity has the phase of FIG. 6(d), the pixel values acquired by the combining processing are set as illustrated in composite images of FIG. 12.

That is, for the G pixel value, the pixel values corresponding to all pixels of the local region of interest can be acquired, based on the pixel values of the local regions having two different phases.

However, for R and B pixel values, the pixel values of the pixel positions of ½ of the local region can be acquired, but the other pixel values of the remaining ½ pixel positions cannot be obtained.

As described above, in any combining, for G color, the pixel values of all pixel positions are acquired, but for R and B colors, information of 50% of the pixel positions lacks.

In order to set RGB colors to all pixel positions in the local region, the insufficient R and B colors (50%) need to be calculated.

In such a condition, the phase combining unit 104 performs interpolation processing using correlation between a low-frequency component of a G pixel and a low-frequency components of the R and B pixels of the local region.

Specifically, respective R and B pixel values not acquired only by the combining processing are calculated, applying the following (Formula 3) or (Formula 4).

$$\begin{matrix}[ Mathematical Formula 2 ] & \\ {A}_{center} = ( {G}_{center} - avgG ) \frac{avgA}{avgG} + avgA & \{ Formula 3 ] \\ {A}_{center} = ( {G}_{center} - avgG ) + avgA \\ A = R , B & [ Formula 4 ]\end{matrix}$$

In (Formula 3) and (Formula 4),

A represents R or B.

In (Formula 3) and (Formula 4),

center represents a pixel value calculation position,

Acenter represents a pixel value (R pixel value or B pixel value) calculated at the pixel value calculation position,

Gcenter represents the G pixel value at the pixel value calculation position (pixel position of Acenter),

avgA represents an average pixel value of A pixel values around the pixel value calculation position, and

avgG represents an average G pixel value at A positions around the pixel value calculation position.

For example, exemplary interpolation processing will be described which is performed when images obtained by combining the local regions having two phases are the composite images illustrated in FIG. 11.

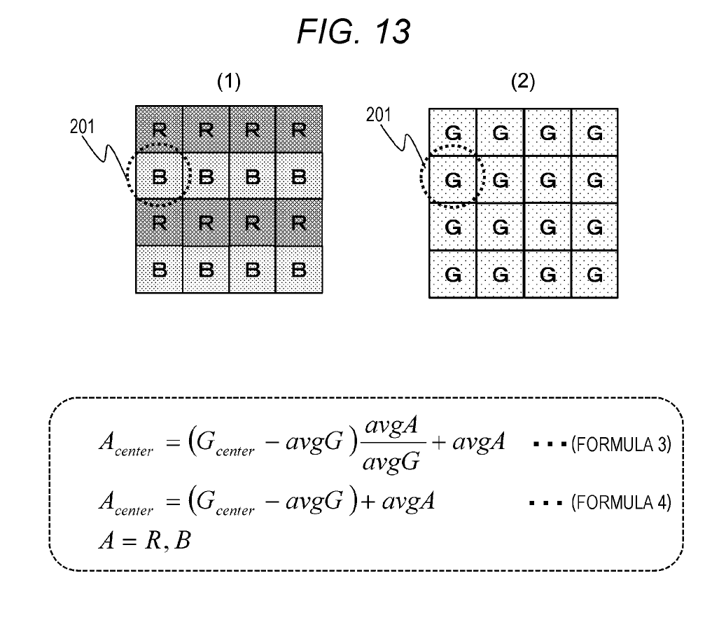

Images (1) and (2) illustrated in FIG. 13 correspond to two composite images illustrated in FIG. 11.

A pixel position 201 of the composite image (1) illustrated in FIG. 13 is at a position from which the R pixel value cannot be acquired from the composite image. When the R pixel value is set to the pixel position 201, the above-mentioned (Formula 3) or (Formula 4) is applied.

As the pixel value calculation position (center), a pixel value to be calculated is defined as the R pixel value (Rcenter).

For example, each parameter applied to the above-mentioned (Formula 3) or (Formula 4) is set as follows:

Gcenter is the G pixel value at a pixel position 202;

aveA=aveR is an average value of the R pixel values located above and below the pixel position 201; and

aveG is an average value of three G pixels, i.e., the G pixel at the pixel position 202, and the G pixels located above and below the pixel position 202.

The parameters are set as described above, and the above-mentioned (Formula 3) or (Formula 4) is applied to calculate the R pixel value (Rcenter) at the pixel value calculation position (center) 201.

The same processing is also applied to the other pixel positions, and the R pixel values at B pixel positions of the composite image of FIG. 13 (1) can be calculated.

The same is also applied to the B pixel values to R pixel positions of the composite image of FIG. 13 (1), and the above-mentioned (Formula 3) or (Formula 4) can be applied to calculate the B pixel values.

As described above, the above-mentioned (Formula 3) or (Formula 4) can be applied to set the RGB pixel values to all pixel positions in the local region of interest being the local region to be demosaiced.

As described above, even from the composite images using the local regions having only two different phases, by the interpolation processing applying the above-mentioned (Formula 3) or (Formula 4), all RGB colors can be set to all pixel positions of the local region of interest to be demosaiced.

Compared with the above-mentioned processing according to the first embodiment, employing the local regions having four phases, this processing has the following advantages:

as the number of phases to be processed is reduced, costs for search processing and combining processing are reduced; and

when it is difficult to find the similar regions having phases of all patterns, this processing provides robust operation.

For example, even if the similar regions having different phases to the local region of interest cannot be found at a place, the similar regions having two phases may be found at the place. In such a condition, combining using the similar regions having two phases with high similarity can have a good result, compared with forcible combining of the local regions having four phases with low similarity.

Alternatively, the phase combining unit 104 may perform hybrid combining configured to selectively apply the above-mentioned two-phase combining, or the four-phase combining having been described in the first embodiment.

For example, when the four similar regions having different phases with high similarity (satisfying a standard) are detected in a predetermined region to be searched, the four-phase combining is performed, and when the four similar regions are not detected, the two-phase combining is performed.

Since the processing is performed as described above, robustness of the processing can also be improved without deteriorating resolution performance.

### 3-2. Third Embodiment

### Embodiment of Processing Using All Similar Local Regions Having Similarity Larger than or Equal to Predetermined Similarity

Next, a third embodiment of an image processing apparatus according to the present disclosure will be described.

The image processing apparatus of the present third embodiment also includes, for example, an imaging apparatus illustrated in FIG. 1, similar to the first embodiment having been described above.

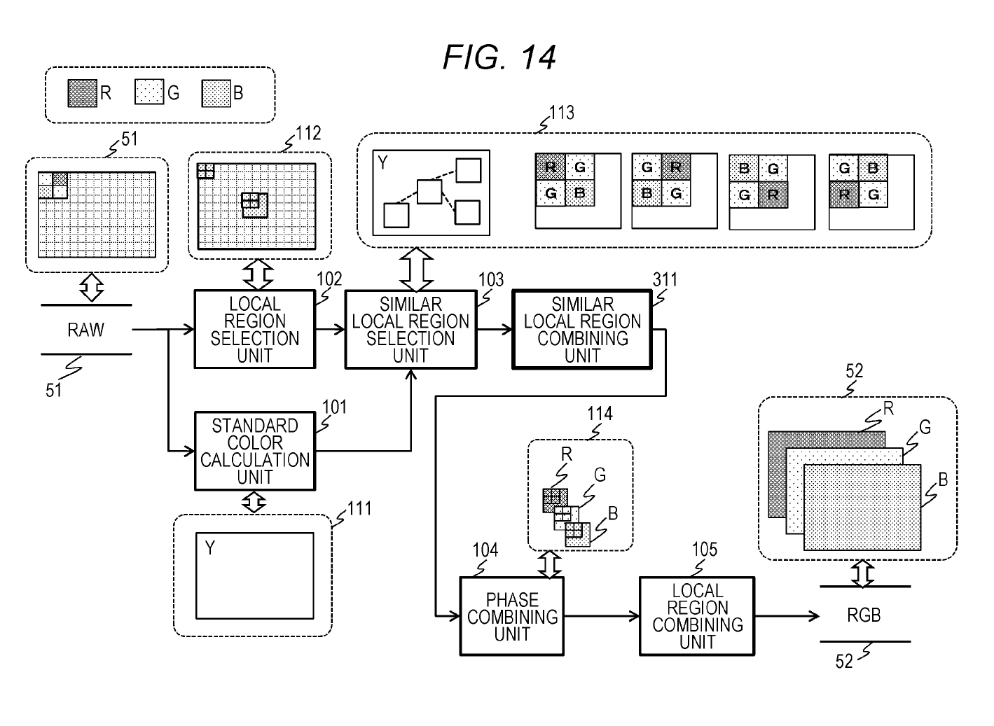

A configuration and processing of an image processing unit 16 will be described with reference to FIG. 14. The image processing unit illustrated in FIG. 14 has a configuration similar to the configuration of FIG. 3 having been described as the configuration of the image processing unit 16 of the first embodiment.

As illustrated in FIG. 14, the image processing unit of the present embodiment is different in that a similar local region combining unit 311 is added subsequent to a similar local region selection unit 103.

A standard color calculation unit 101, a local region selection unit 102, a phase combining unit 104, and a local region combining unit 105 are configured to perform processing similar to the processing having been described with reference to FIG. 3, as the first embodiment, and description will be omitted.

Here, processing of the new similar local region combining unit 311 will be mainly described.

The similar local region combining unit 311 performs similarity determination for each local region by applying a standard color image, selects a local region having high similarity for each phase, and combines the local regions.

In the above-mentioned first embodiment, the similar local region selection unit 103 selects one local region having the largest similarity for each phase, and combines the selected local regions in the phase combining unit 104.

In the present embodiment, the similar local region selection unit 103 selects all similar local regions having similarities larger than a standard, for example, a degree of similarity as a predetermined threshold.

That is, in the present embodiment, the similar local region selection unit 103 does not select one similar local region for each phase, but selects all similar local regions having similarities larger than or equal to the predetermined threshold, for each phase, and outputs the similar local regions to the similar local region combining unit 311.

The similar local region combining unit 311 combines a plurality of similar local regions for each phase, generates one piece of similar local region pixel data for each phase, and outputs the data to the phase combining unit 104.

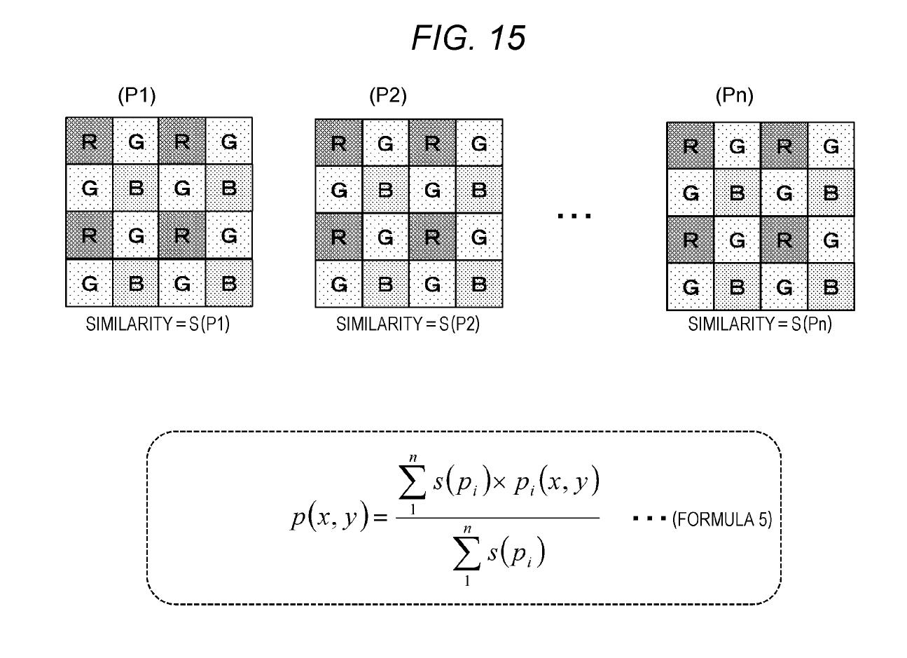

Processing performed by the similar local region combining unit 311 will be described with reference to FIG. 15.

FIG. 15 illustrates n similar local region groups ((P1) to (Pn)) satisfying a predetermined standard of similarity to a specific phase selected by the similar local region selection unit 103.

S(Pi) represents similarity of a local region Pi.

By applying the n similar local region groups ((P1) to (Pn)) satisfying the predetermined standard of similarity, the similar local region combining unit 311 generates a local similar region composite image corresponding to one phase based on each pixel value of the n similar local region groups ((P1) to (Pn)), according to the following (Formula 5). The following (Formula 5) is a formula for calculating an output pixel value by subjecting the pixel value at a corresponding pixel position of each similar local region to weighted summation so that a pixel value of the similar local region having a larger similarity has a larger weight.

$$\begin{matrix}[ Mathematical Formula 3 ] & \\ p ( x , y ) = \frac{{\sum }_{1}^{n} s ( {p}_{i} ) \times {p}_{i} ( x , y )}{{\sum }_{1}^{n} s ( {p}_{i} )} & [ Formula 5 ]\end{matrix}$$

In (Formula 5), p(x,y) calculated according to the formula represents the pixel value at a pixel position (x,y) in the local similar region having the specific phase, calculated by the combining processing.

As described above, the pixel value of a corresponding pixel of the similar local region having the same phase having a certain similarity is subjected to the weighted summation according to the similarity, data about the similar local region corresponding to each phase is generated, and the generated data about the similar local region is output to the phase combining unit 104.

Owing to this processing, all similar local regions are involved by weighting according to similarity, in the present embodiment, although only one local region is involved for each phase in the first embodiment, and a noise reduction effect is added. Subsequent processing is similar to the first embodiment.

It is noted that, in each embodiment, description has been made of processing of the input raw image format having the Bayer array, but the processing of the present disclosure can also be applied to a captured image having another color array. If similar local regions are selected by the number of phases of a color array of a captured image, and the selected similar local regions are combined, pixel values of all colors can be set to all pixels of a local region, and processing similar to each of the above-mentioned embodiments can be performed.

Further, in each of the above mentioned embodiments, description has been made of examples of the demosaic processing performed by inputting the image captured by the imaging device having a specific color filter array such as the Bayer array, but, as a preliminary step of the demosaic processing, noise reduction may be performed for the input image.

The noise reduction can be performed as the preliminary step of the demosaic processing, and noise reduction effect is further improved. It is noted that, as a noise reduction method, various techniques, for example, an ε filter, a bilateral filter, non local means, or wavelet shrinkage can be applied.

A plurality of embodiments of the image processing apparatus according to the present disclosure has been described.

The above-mentioned demosaic processing of the present disclosure has the following features:

the demosaicing by combining the phases for each local region, considerably reduces a conventional risk of the variation in demosaicing accuracy for each pixel position;

combining the phases by collecting the similar regions having different phases from the periphery using image self-similarity provides super-resolution effect, and results in highly accurate demosaicing;

determining the local region similarity based on the standard color having been calculated facilitates determination of the local regions having similar but different phases; and

a highly accurate demosaicing result can be obtained from one input image without using a plurality of input images.

### 4. Summary of Configuration of Present Disclosure

The embodiments of the present disclosure has been described in detail with reference to the specific embodiments. However, it is obvious that those skilled in the art can make modifications and substitutions of the embodiments without departing from the scope of the present disclosure. That is, the present invention has been disclosed in the form of embodiments, but should not be understood as limiting. In order to determine the scope of the present disclosure, the scope of claims should be taken into consideration.

The techniques having been disclosed in the present description can have the following configurations.

(1) An image processing apparatus including

an image processing unit configured to set pixel values of a plurality of colors to each pixel position of an input image being a raw image format only having a pixel value of a specific color set to each pixel,

the image processing unit including:

a local region selecting unit configured to select a local region of interest, as a region to be processed, from the input image;

a standard color image generating unit configured to generate a standard color image based on the input image;

a similar local region selection unit configured to select a similar local region having a phase different from that of the local region of interest, and determined, based on the standard color image, to have high similarity to the local region of interest;

a phase combining unit configured to generate a local region image set with a plurality of colors, having the pixel values of the plurality of colors set to each pixel position of component pixels of the local region of interest by combining the local region of interest and the similar local region; and

a local region combining unit configured to input the local region image set with a plurality of colors corresponding to different local regions of interest generated by the phase combining unit, combine the local region images corresponding to a plurality of colors, as the image to be input, and generate an image set with a plurality of colors, having the pixel values of the plurality of colors set to each pixel position of the component pixels of the input image.

(2) The image processing apparatus according to (1), in which the input image is a raw image format only having one RGB pixel value set to each pixel position, the phase combining unit generates a local region image set with RGB, having all RGB pixel values set to each pixel position of component pixels of the local region of interest, and the local region combining unit generates an image set with RGB having the all RGB pixel values set to each pixel position of the component pixels of the input image.

(3) The image processing apparatus according to (1) or (2), in which the standard color image generating unit generates a standard color image having a frequency lower than a sampling frequency of the raw image format.

(4) The image processing apparatus according to any of (1) to (3), in which the standard color image generating unit generates a luminance image having a frequency lower than the sampling frequency of the raw image format.

(5) The image processing apparatus according to any of (1) to (4), in which the standard color image generating unit generates a standard color image having a cutoff frequency within the range from the sampling frequency fs corresponding to a pixel of a color occupying the largest number of pixels of the raw image format, to ½ of a Nyquist frequency, i.e., fs/4.

(6) The image processing apparatus according to any of (1) to (5), in which the raw image format is a Bayer array image, the similar local region selection unit selects three similar local regions corresponding to three different phases corresponding to three kinds of phases different from the local region of interest, and the phase combining unit generates a local region image set with RGB colors, having each RGB pixel value set to each pixel position of component pixels of the local region of interest by combining the local region of interest and the three similar local regions corresponding to the three different phases.

(7) The image processing apparatus according to any of (1) to (5), in which the raw image format is a Bayer array image, the similar local region selection unit selects one similar local region having a phase different from that of the local region of interest, and the phase combining unit combines the local region of interest and the one similar local region, further calculates, by interpolation processing, a pixel value of a pixel position from which the pixel value cannot be acquired, in the combining processing, and generates a local region image set with RGB colors, having each RGB pixel value set to each pixel position of the component pixels of the local region of interest.

(8) The image processing apparatus according to any of (1) to (7), in which the image processing unit further includes a similar local region combining unit, the similar local region selection unit selects, for each phase, a plurality of similar local regions having phases different from that of the local region of interest and determined to have high similarity to the local region of interest, based on the standard color image, and outputs the selected similar local regions to the similar local region combining unit, and the similar local region combining unit generates one piece of similar local region data for each phase by combining the plurality of similar local regions of each phase, and outputs the generated data to the phase combining unit.

(9) The image processing apparatus according to (8), in which the similar local region combining unit performs combining processing by applying weighted addition according to a weight based on similarity to the local region of interest of each similar local region, and generates one piece of similar local region data for each phase, when combining a plurality of similar local regions for each phase.

Furthermore, the configuration of the present disclosure also includes a processing method performed in the apparatus and the system, a program for executing the processing, or a recording medium on which the program is recorded.

It is noted that a series of processing having been described in the description can be performed by hardware, software, or a composite configuration of them. When the processing is performed by the software, the program in which a processing sequence is recorded can be executed by being installed in a memory in a computer incorporated in dedicated hardware, or by being installed in a general-purpose computer capable of performing various processing. For example, the program can be recorded in the recording medium beforehand. The program can be installed in the computer from the recording medium, or the program can be received through a network such as a local area network (LAN) or the Internet to be installed in the recording medium such as a built-in hard disk.

It is noted that the various processing in the description may not only be performed in time-series according to the description, but also be performed simultaneously or separately according to a processing capacity of an apparatus performing the processing or if desired. Furthermore, it is noted that the system described in the present description is a logical set configuration of a plurality of apparatuses, and the apparatuses of the respective configurations are not limited to be housed within the same housing.

### INDUSTRIAL APPLICABILITY

As described above, according to one embodiment of the present disclosure, an apparatus and a method are provided which have a simple configuration to perform highly accurate demosaic processing.

Specifically, a local region of interest being a region to be processed is selected from a raw image format, and a standard color image is generated based on an input image. Further, a similar local region is selected which has a phase different from that of the local region of interest, and is determined to have high similarity to the local region of interest based on the standard color image. Further, the local region of interest and the similar local region are combined to generate a local region image set with RGB, having each RGB pixel value set to each pixel position of component pixels of the local region of interest. Further, the local region images set with RGB corresponding to different local regions of interest are combined to generate an RGB image having each RGB pixel value set to each pixel position of component pixels of the input raw image format.

The present configuration achieves the apparatus and the method which have a simple configuration to perform highly accurate demosaic processing.

### REFERENCE SIGNS LIST

10 Imaging apparatus
11 Lens
12 Diaphragm
13 Imaging device
14 Sampling circuit
15 A/D (Analog/Digital) conversion unit
16 Image processing unit (DSP)
17 Encoding/decoding unit
18 Memory
19 D/A (Digital/Analog) conversion unit
20 Video encoder
21 Display unit
22 Timing generation unit
23 Operation input unit
24 Driver
25 Control unit
51 RAW image format
52 RGB image
101 Standard color calculation unit
102 Local region selection unit
103 Similar local region selection unit
104 Phase combining unit
105 Local region combining unit
311 Similar local region combining unit

1. An image processing apparatus comprising:
an image processing unit configured to set pixel values of a plurality of colors to each pixel position of an input image being a raw image format only having a pixel value of a specific color set to each pixel,
the image processing unit comprising:
a local region selecting unit configured to select a local region of interest, as a region to be processed, from the input image;
a standard color image generating unit configured to generate a standard color image based on the input image;
a similar local region selection unit configured to select a similar local region having a phase different from that of the local region of interest, and determined, based on the standard color image, to have high similarity to the local region of interest;
a phase combining unit configured to generate a local region image set with a plurality of colors, having the pixel values of the plurality of colors set to each pixel position of component pixels of the local region of interest by combining the local region of interest and the similar local region; and
a local region combining unit configured to input the local region image set with a plurality of colors corresponding to different local regions of interest generated by the phase combining unit, combine the local region images corresponding to a plurality of colors, as the image to be input, and generate an image set with a plurality of colors, having the pixel values of the plurality of colors set to each pixel position of the component pixels of the input image.

2. The image processing apparatus according to claim 1, wherein
the input image is a raw image format only having one RGB pixel value set to each pixel position,
the phase combining unit generates a local region image set with RGB, having all RGB pixel values set to each pixel position of component pixels of the local region of interest,
and the local region combining unit generates an image set with RGB having the all RGB pixel values set to each pixel position of the component pixels of the input image.

3. The image processing apparatus according to claim 1, wherein
the standard color image generating unit generates a standard color image having a frequency lower than a sampling frequency of the raw image format.

4. The image processing apparatus according to claim 1, wherein
the standard color image generating unit generates a luminance image having a frequency lower than the sampling frequency of the raw image format.

5. The image processing apparatus according to claim 1, wherein
the standard color image generating unit generates a standard color image having a cutoff frequency within the range from the sampling frequency fs corresponding to a pixel of a color occupying the largest number of pixels of the raw image format, to ½ of a Nyquist frequency, fs/4.

6. The image processing apparatus according to claim 1, wherein
the raw image format is a Bayer array image,
the similar local region selection unit selects three similar local regions corresponding to three different phases corresponding to three kinds of phases different from the local region of interest, and
the phase combining unit generates a local region image set with RGB colors, having each RGB pixel value set to each pixel position of component pixels of the local region of interest by combining the local region of interest and the three similar local regions corresponding to the three different phases.

7. The image processing apparatus according to claim 1, wherein
the raw image format is a Bayer array image,
the similar local region selection unit selects one similar local region having a phase different from that of the local region of interest, and
the phase combining unit combines the local region of interest and the one similar local region, further calculates, by interpolation processing, a pixel value of a pixel position from which the pixel value cannot be acquired, in the combining processing, and generates a local region image set with RGB colors, having each RGB pixel value set to each pixel position of the component pixels of the local region of interest.

8. The image processing apparatus according to claim 1, wherein
the image processing unit further includes a similar local region combining unit,
the similar local region selection unit selects, for each phase, a plurality of similar local regions having phases different from that of the local region of interest and determined to have high similarity to the local region of interest, based on the standard color image, and outputs the selected similar local regions to the similar local region combining unit, and
the similar local region combining unit generates one piece of similar local region data for each phase by combining the plurality of similar local regions of each phase, and outputs the generated data to the phase combining unit.

9. The image processing apparatus according to claim 8, wherein
the similar local region combining unit performs combining processing by applying weighted addition according to a weight based on similarity to the local region of interest of each similar local region, and generates one piece of similar local region data for each phase, when combining a plurality of similar local regions for each phase.

10. An image processing method performed in an image processing apparatus, the method comprising:
image processing for setting pixel values of a plurality of colors to each pixel position of an input image being a raw image format only having a pixel value of a specific color set to each pixel, the image processing being performed by an image processing unit,
the image processing comprising:
a local region selecting unit for selecting, from the input image, a local region of interest as a region to be processed;
a standard color image generating process for generating a standard color image based on the input image;
a similar local region selecting process for selecting a similar local region having a phase different from that of the local region of interest, and determined, based on the standard color image, to have high similarity to the local region of interest;
a phase combining process for generating a local region image set with a plurality of colors, having the pixel values of the plurality of colors set to each pixel position of component pixels of the local region of interest by combining the local region of interest and the similar local region; and
a local region combining process for inputting the local region image set with a plurality of colors corresponding to different local regions of interest generated by the phase combining unit, combining the local region images corresponding to a plurality of colors, as the images to be input, and generating an image set with a plurality of colors, having the pixel values of the plurality of colors set to each pixel position of the component pixels of the input image.

11. A program for causing an image processing apparatus to perform image processing,
the program causing an image processing unit to perform the image processing for setting pixel values of a plurality of colors to each pixel position of an input image being a raw image format only having a pixel value of a specific color set to each pixel,
the image processing comprising:
a local region selecting unit for selecting a local region of interest as a region to be processed, from the input image;
a standard color image generating process for generating a standard color image based on the input image;
a similar local region selecting process for selecting a similar local region having a phase different from that of the local region of interest, and determined, based on the standard color image, to have high similarity to the local region of interest;
a phase combining process for generating a local region image set with a plurality of colors, having the pixel values of the plurality of colors set to each pixel position of component pixels of the local region of interest by combining the local region of interest and the similar local region; and
a local region combining process for inputting the local region image set with a plurality of colors corresponding to different local regions of interest generated by the phase combining unit, combining the local region images corresponding to a plurality of colors, as the images to be input, and generating an image set with a plurality of colors, having the pixel values of the plurality of colors set to each pixel position of the component pixels of the input image.
